(19) United States
(12) Patent Application Publication
(10) Pub. No.: US 2008/0300742 A1
(43) Pub. Date: Dec. 4, 2008

(54) Hybrid remotely/autonomously operated underwater vehicle

(75) Inventors: David Weaver, Severna Park, MD (US); Thomas Tolman, Annapolis, MD (US); David Boyd, Pasadena, MD (US); Shawn Dann, Severna Park, MD (US); Patrick Mohr, Crofton, MD (US); Trevor Miller, Laurel, MD (US)

Correspondence Address: MCKENNA LONG & ALDRIDGE LLP, 1900 K STREET, NW, WASHINGTON, DC, 20006, US

(73) Assignee: Oceaneering International, Inc., Houston, TX (US)

(21) Appl. No.: 11/806,236

(22) Filed: May 30, 2007

(51) Int. Cl. G05D 1/10; B63G 8/00

(52) U.S. Cl. 701/21; 114/312

(57) ABSTRACT

Disclosed is an underwater vehicle that can be operated as a remotely operated vehicle (ROV) or as an autonomous vehicle (AUV). The underwater vehicle has a tether, which may be a fiberoptic cable, that connects the vehicle to a control console. The underwater vehicle has vertical and lateral thrusters, pitch and yaw control fins, and a propulsor, all of which may be used in an ROV-mode when the underwater vehicle is operating at slow speeds. The underwater vehicle may also be operated in a AUV-mode when operating at higher speeds. The operator may switch the vehicle between ROV-mode and AUV-mode. The underwater vehicle also has a fail-safe mode, in which the vehicle may navigate according to a pre-loaded mission plan if the tether is severed.

### BACKGROUND OF THE INVENTION

1. Field of the Invention

The present invention generally relates to unmanned vehicles. More particularly, the present invention relates to unmanned underwater vehicles.

2. Discussion of the Related Art

Remotely operated underwater vehicles and autonomously operated underwater vehicles have found many applications, including inspection and repair of offshore oil rigs and ships, and the exploration of shipwrecks and underwater caves. Advances in electronics, computation, and communication systems have provided unmanned underwater vehicles with increased capability, both in terms of the sensors that the vehicle can carry, and in terms of maneuverability.

Related art unmanned underwater vehicles can be classified as remotely operated vehicles (“ROV”), or autonomously operated vehicles (“AUV”). ROVs generally include an umbilical cable that provides control signals and electrical power from a host vessel to the ROV. An operator, who is onboard the host vessel, operates the ROV using joystick-type and other controls at an operator console. The ROV may have sensors, such as a camera, whereby the signals from the sensors are transmitted to the operator console via the umbilical cable.

Related art ROVs have a disadvantage in that if the umbilical cable is entangled or severed, the ROV is lost. This may be a particular disadvantage if the ROV is operating in a hostile environment, such as a shipwreck, that has structures with sharp features that are likely to entangle or sever the umbilical cable.

AUVs generally function without having an operator in the control loop. Accordingly, AUVs rely on onboard computing power to carry out a predetermined mission. The size and complexity of an AUV may depend on the nature of its intended mission, the mission's duration, and the mission's complexity.

AUVs offer certain advantages over ROVs. AUVs generally operate without an umbilical cable, which mitigates the above disadvantage of ROVs. Other AUV advantages include the ability to operate without the host vessel, a greater operating range, and an operating paradigm that is decoupled in both control and time space. Another advantage of AUVs is that an AUV can navigate autonomously, relieving an operator of this task.

However, AUVs generally have the following disadvantages. First, depending on the AUV's onboard computing capability, an AUV may not offer much flexibility in its mission. It may require considerable effort beforehand to program an AUV for a particular mission while trying to anticipate all contingencies. Second, providing the AUV with sufficient computing capability to carry out complex missions greatly increases the cost of the AUV. And third, given its increased complexity, and the cost to develop and test sophisticated algorithms, an AUV requires more specialized personnel to maintain, program, and deploy.

Accordingly, what is needed is an unmanned underwater vehicle that offers the low cost and flexibility of an ROV, as well as the recoverability and autonomous navigation of an AUV.

### SUMMARY OF THE INVENTION

The present invention provides a hybrid remotely/autonomously operated underwater vehicle that obviates one or more of the aforementioned problems due to the limitations of the related art.

Accordingly, one advantage of the present invention is that it improves the recoverability of a remotely operated unmanned underwater vehicle if the vehicle's tether is severed.

Another advantage of the present invention is that it reduces the cost and complexity of an unmanned underwater vehicle having autonomous navigation capability by providing operator decision-making when unforeseen circumstances are encountered.

Yet another advantage of the present invention is that it enhances the telemetry provided by an AUV.

Additional advantages of the invention will be set forth in the description that follows, and in part will be apparent from the description, or may be learned by practice of the invention. The advantages of the invention will be realized and attained by the structure pointed out in the written description and claims hereof as well as the appended drawings.

To achieve these and other advantages, the present invention involves an underwater vehicle. The underwater vehicle comprises a tether; a communications device coupled to the tether; an ROV controller that controls the underwater vehicle according to an ROV-mode; an AUV controller that controls the underwater vehicle according to an AUV-mode; and an ROV/AUV mode switch that switches the underwater vehicle between the ROV-mode and the AUV-mode.

In another aspect of the present invention, the aforementioned and other advantages are achieved by an underwater vehicle, which comprises a lateral thruster; a vertical thruster; a pitch control fin; a yaw control fin; a propulsor; an ROV controller coupled to the lateral thruster and the vertical thruster; and an AUV controller coupled to the pitch control fin, the yaw control fin, and the propulsor, wherein the ROV controller is configured to communicate with the AUV controller.

In another aspect of the present invention, the aforementioned and other advantages are achieved by a vehicle, which comprises a hull; a tether pack disposed within the hull, wherein the tether pack has a length of tether; and a stinger guide coupled to an aperture in the hull, wherein the tether passes through the aperture and the stinger guide.

In yet another aspect of the present invention, the aforementioned and other advantages are achieved by an underwater vehicle, which comprises a hull; an antenna mast disposed on a topside of the hull; and a keel disposed on an underside of the hull, wherein the keel has a trim pack disposed at an end of the keel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates an exemplary underwater vehicle system according to the present invention.

FIG. 2A illustrates a forward section of the vehicle of FIG. 1.

FIG. 2B illustrates an exemplary thruster cover according to the present invention.

FIG. 3A illustrates an exemplary tether pack according to the present invention.

FIG. 3B illustrates an exemplary stinger guide.

FIG. 4 illustrates an exemplary trim pack and keel of the vehicle of FIG. 1.

FIG. 5 is an exemplary process for determining and allocating weights for the trim pack of FIG. 4.

FIG. 6 illustrates an exemplary electronics system for an underwater vehicle according to the present invention.

FIG. 7 illustrates an exemplary deployment of an underwater vehicle according to the present invention.

### DETAILED DESCRIPTION OF THE ILLUSTRATED EMBODIMENTS

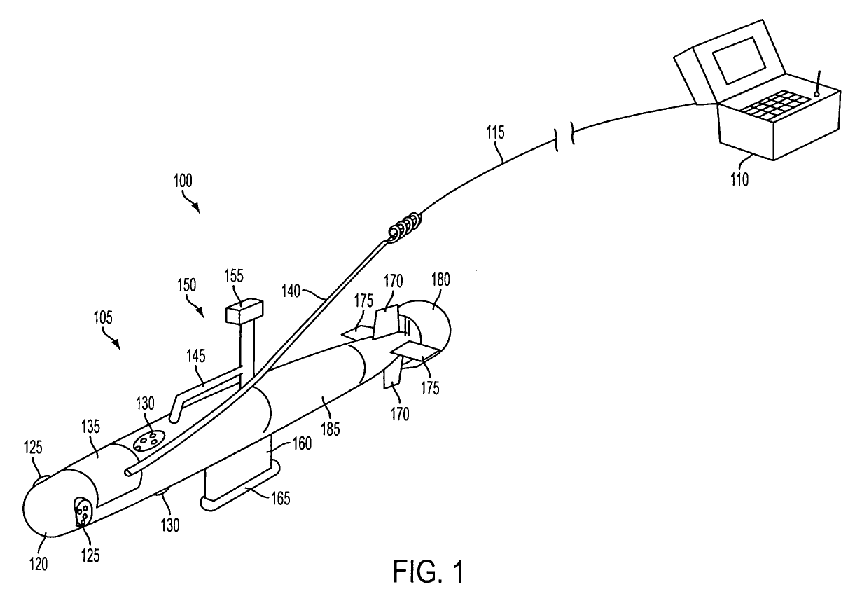

FIG. 1 illustrates an exemplary underwater vehicle system 100 according to the present invention. Underwater vehicle system 100 includes a vehicle 105 and a control console 110, which are connected by a tether 115. Vehicle 105 may include a sensor package 120, at least one lateral thruster 125, at least one vertical thruster 130, and a tether pack 135. Tether pack 135, which is disposed within the hull of vehicle 105, has a length of tether 115. Vehicle 105 further includes a handle 145 and antenna mast 150. Handle 145 and antenna mast 150 may be integrated into a single unit. Disposed on antenna mast 150 is an antenna package 155, which may include a Global Positioning System (GPS) receiver, a data communications antenna, and a camera. Vehicle 105 may further include a keel 160, which has a trim pack 165.

Vehicle 105 may further include an electronics system 185 disposed within the hull of vehicle 105, a set of yaw control fins 170, a set of pitch control fins 175, and a propulsor 180.

Tether 115 may be fed out through “stinger” guide 140. Tether 115 may be a fiberoptic cable, although other cables may be used, depending on the bandwidth requirements, length, weight, and flexibility of tether 115.

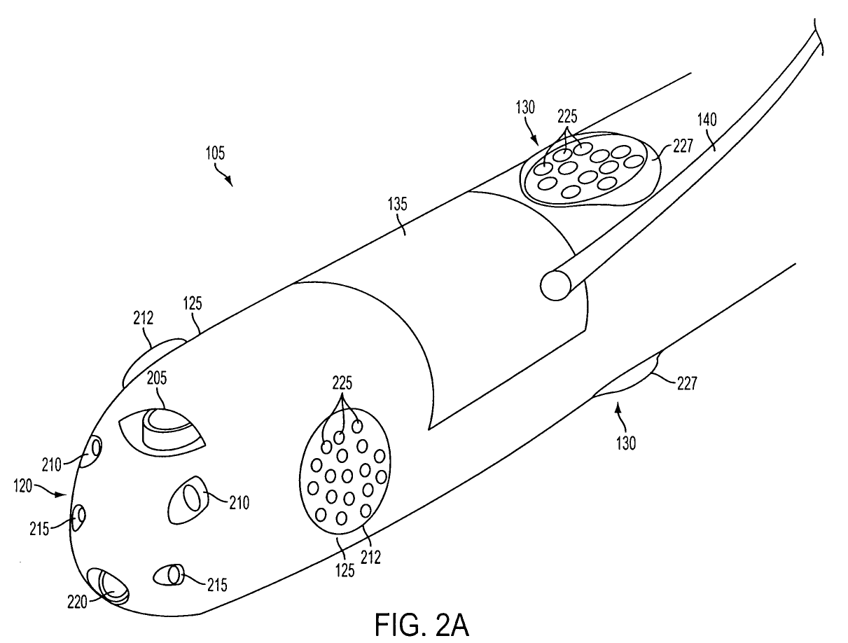

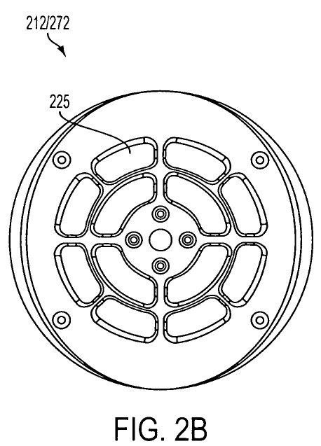

FIG. 2A illustrates a forward section of vehicle 105 according to the present invention. As illustrated in FIG. 2A, sensor package 120 may include a plurality of sensors, including a scanning sonar 205, two Light Emitting Diode (LED) lights 210, two lasers 215, and a camera 220. Scanning sonar 205 may operate at about 675-700 kHz within a range of about 100 meters, although variations to scanning sonar 205 are possible and within the scope of the invention. LED lights 210 may be pressure tolerant devices that provide enough light to illuminate the area in front of vehicle 105 and be seen by camera 220. The luminosity of LED lights 210 may be around 160 lumens, although other luminosities are possible, depending on the operating environment of vehicle 105 and the number of LED lamps 210 used.

Lasers 215 may include two pressure tolerant red lasers, which are aligned so that their beams are substantially parallel. Further, the direction of the beams of lasers 215 may be such that backscatter from the both beams are within the field of view of camera 220. In this manner, lasers 215 may provide an optical reference by distance. Due to parallax, the spacing between the reflected beams from lasers 220 will be a function of distance between sensor package 120 and the object reflecting the laser light. Accordingly, lasers 215, operating in conjunction with camera 220, may provide a visual perception of size of objects. Further, the backscatter of light from lasers 215, as detected by camera 220, may provide an indication of the turbidity of the water in which vehicle 105 is operating. The combination of lasers 215 and camera 220 may be substantially similar to commercially-available sensor systems that are known to the art.

The instruments described above with regard to sensor package 120 are exemplary. One skilled in the art will readily appreciate that many variations to sensor package 120 are possible and within the scope of the invention.

FIG. 2A further illustrates lateral thrusters 125 and vertical thrusters 130. Lateral thrusters 125 may include a lateral thruster cover 212, which has a plurality of apertures 225.

FIG. 2B illustrates an exemplary lateral thruster cover 212 or vertical thruster cover 272 according to the present invention. FIG. 2B further illustrates apertures 225. The dimension and shape of apertures 225 may be such that they minimally interfere with water flow, while not allowing tether 115 or other objects to be ingested into the thruster (lateral thruster 125 or vertical thruster 130 when the thruster is operating at maximum thrust. Accordingly, the dimensions of apertures 225 are a function of the maximum thrust of the thruster, the rigidity of tether 115, and a minimum bend radius of tether 115. For example, apertures 225 may be configured to have a maximum opening size of approximately ⅜″×1.0″.

Referring again to FIG. 2A, lateral thrusters 125 may include a plurality of motors and propellers. Alternatively, lateral thrusters 125 may include a single motor and propeller, which is disposed within the hull of vehicle 105 and between lateral thruster covers 212. One skilled in the art will readily appreciate variations to lateral thruster 125, including lateral thruster covers 212 and apertures 225, are possible and within the scope of the invention.

Vertical thrusters 130 may be substantially similar to lateral thrusters 125. However, vertical thrusters 130 may vary, depending on the thrust requirements for vertical translation vs. lateral translation. Accordingly, if the thrust provided by vertical thrusters 130 is greater than that of lateral thrusters 125, then the dimensions of apertures 225 in vertical thruster covers 227 may vary from those of lateral thruster covers 212. For example, vertical thrusters 130 provide more thrust than lateral thrusters 125, then the apertures 225 of vertical thruster cover 227 may be smaller than those of lateral thruster cover 212.

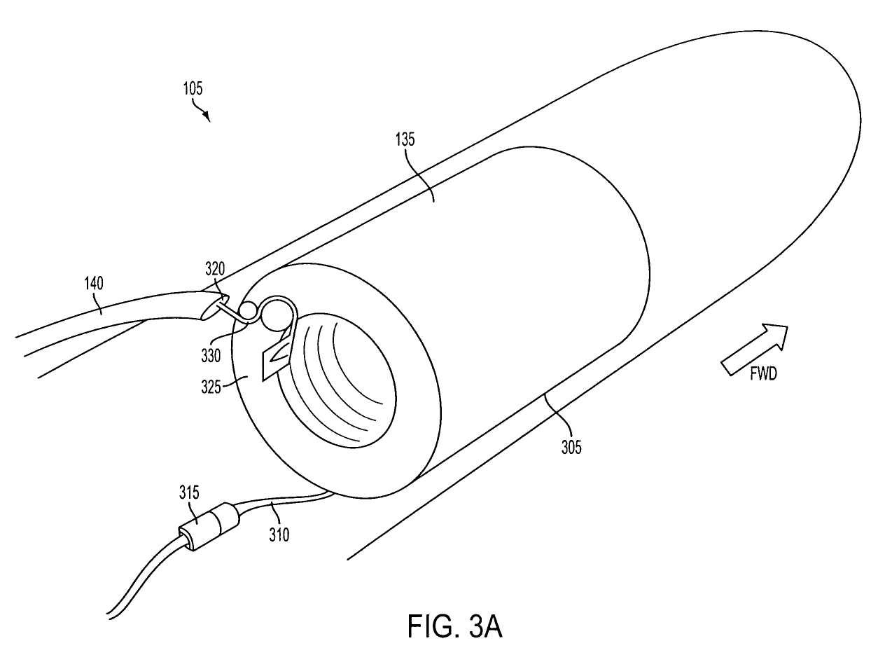

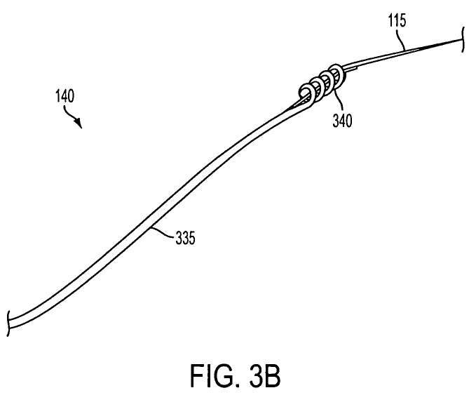

FIG. 3A illustrates an exemplary tether pack 135 according to the present invention. The embodiment described herein pertains to tether 115 being a fiberoptic cable. However, one skilled in the art will recognize that, as described above, other types of cable may be used for tether 115 within the scope of the invention.

Tether pack 135 is illustrated in FIG. 3A as being mounted within the hull of vehicle 105. Tether pack 135 may included a case 305, a full-extension cable cutter 325, and at least one binder-stripping wheel 330. Also illustrated is an aperture 320 in the hull of vehicle 105, to which stinger guide 140 may attach, and through which tether 115 enters stinger guide 140. Tether pack 135 may also have a lead cable 310, to which tether 115 connects to the electronics system 185 at connector 315.

Tether pack 135 may be mounted within vehicle 105 such that it may be replaced in a modular fashion. The amount of tether 115 spooled within case 305 may vary, depending on the mission intended for vehicle 105 and the dimensions and weight of the cable used for tether 115. In the case in which tether 115 is a fiberoptic cable, up to approximately 2 km of tether 115 may be stored within case 305.

Tether 115 that is spooled within case 305 may be coated with a binder material, which prevents the spooled tether 15 from sliding and becoming entangled within case 305.

Full extension cable cutter 325 may have a cutting device, which severs tether 15 if vehicle 105 reaches the end of tether 115. This may prevent vehicle 105 and control console 110 from being damaged by the sudden tension on a fully-extended tether 115, and it may ensure that vehicle 105 is not captured by reaching the end of tether 15. If vehicle 105 reaches the end of tether 15, and full extension cable cutter 325 cuts tether 115, the vehicle switches into autonomous mode, as is described further below. This is in contrast to an ROV of the related art, in which a vehicle that reaches the full extent of its tether may damage or trap the vehicle and/or the tether, in which case the vehicle may be lost.

The at least one binder stripper wheel 330 may relieve tension on tether 115 as it is being spooled out. Further, binder stripper wheel 330 may include a groove at its outer circumference, in which tether 115 sits as binder stripper wheel rolls. Binder stripper wheel 330 may have a radius that is greater than the minimum bend radius of tether 115, such as a fiberoptic cable, so that sharp bends are mitigated. In doing so, loss of signal due to loss of total internal reflection of the fiberoptic cable may be prevented.

Another function of binder stripper wheel 330 is to strip the binder material off of the outer surface of tether 115 as tether 115 is fed out from tether pack 135. This may prevent binder from accumulating at aperture 320 and inhibiting the feeding out of tether 115 through stinger guide 140.

FIG. 3B illustrates an exemplary stinger guide 140 according to the present invention. Stinger guide 140 may include a guide portion 335 and a tail portion 340. Guide portion 335 may be made of a flexible tubing that is sufficiently stiff to prevent tether 115 from being ingested by propulsor 180 when propulsor 180 is providing maximum thrust. However, guide portion 335 should also have a sufficient flexibility to provide bend and strain relief at tail portion 340 if tether 115 is under tension in a direction having acute angle relative to the direction of stinger guide 140. In an exemplary embodiment, guide portion 335 may be constructed from polyethylene or PTFE (Teflon), although other materials may be used.

Tail portion 330 may be formed of the same material as guide portion 335 that is cut into a spiral shape. Tail portion 340 may be more flexible than guide portion 335 to provide strain relief if tether 115 is under tension in a direction having acute angle relative to the direction of stinger guide 140. Accordingly, depending on the relative flexibility between guide portion 335 and tail portion 340, strain imparted on tether 115 may be substantially mitigated while tether 115 is kept from being ingested by propulsor 180 when propulsor 180 is providing maximum thrust. One skilled in the art will readily recognize that the respective lengths and flexibilities of guide portion 335 and tail portion 340 may be a function of the strength and rigidity of tether 115, and the dimensions and maximum thrust of propulsor 180.

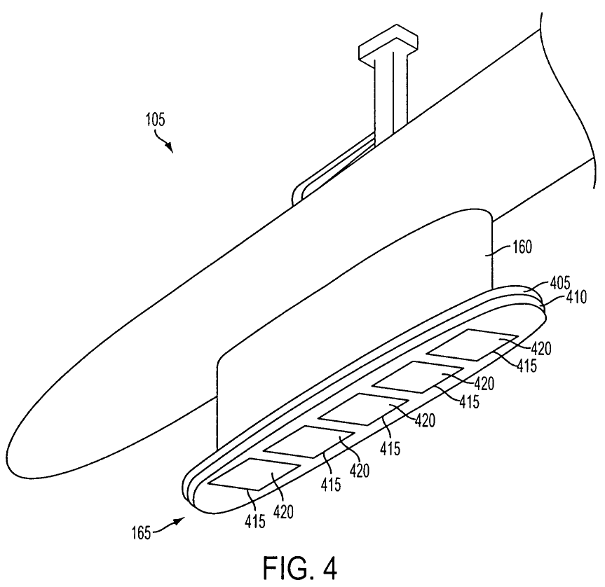

FIG. 4 illustrates vehicle 105 from the underside, including keel 160 and trim pack 165. Keel 160 may have a height (in a direction orthogonal to the length of vehicle 105) sufficient to allow vehicle 105 to be rested on trim pack 165. Also, the height of keel 160 may be selected so that the righting moment of vehicle 105 is improved, which improves the stability of vehicle 105 when it is in the water. Keel 160 may have a length (along the length of vehicle 105) that enhances the stability of vehicle 105 when it is resting on trim pack 165. Other considerations for the length of keel include the ability to distribute weight in trim pack 165 to improve balance and stability about the roll axis of vehicle 105.

Trim pack 165 may have a base plate 405 and a cover plate 410. Cover plate 410 may have a plurality of apertures 415. Disposed within apertures 415 and between base plate 405 and cover plate 410 are trim weights or ballast components 420. The ballast components 420 may be selected and distributed along the length of trim pack 165 to match the density of vehicle with that of the water in which it is to be deployed, so that vehicle 105 may remain at a substantially constant depth in the absence of thrust from vertical thrusters 130 and propulsor 180, thereby saving energy and providing a substantially stable data collection platform.

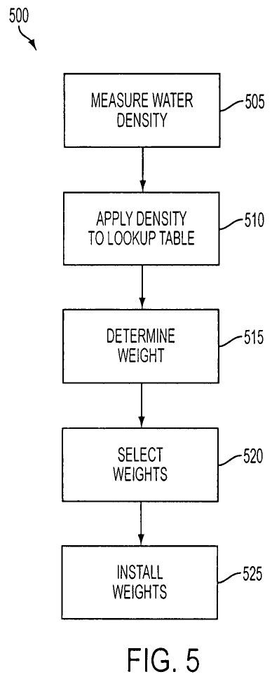

FIG. 5 illustrates an exemplary process 500 for selecting an appropriate combination of ballast components 420 that will match the density of vehicle 105 with that of the water in which it is to be deployed.

At step 505, the specific density of the water is measured. This may be done by using a hydrometer to measure the specific density of the water in which vehicle 105 is to be deployed. One may use a commercially available hydrometer to take the measurement. The specific density of the water is generally a function of salinity and temperature. Accordingly, the specific density should be measured at a location and time close to that in which vehicle 105 will be deployed. One skilled in the art will readily recognize that sufficient proximity in distance and time will depend on the location and other factors.

At step 510, the specific density measurement is applied to a lookup table to determine the weight required to substantially match the density of water to that of vehicle 105. The lookup table may be a multidimensional table, whereby the lookup table may have multiple inputs, such as the type of vehicle 105, the length and type of tether 115, the combination of sensors in the sensor package 120, and other factors that will affect the weight of vehicle 105. The lookup table may be implemented in software and executed on a computer in control console 110, or in a handheld computing device. Alternatively, the lookup table may be a hardcopy paper printout. Although the discussion above describes a lookup table, it will be apparent to one skilled in the art that other ways of determining the appropriate weight to match the specific density may be used, such as a set of equations, and the like.

The appropriate weight is determined in step 515. The output of step 515 includes an amount of weight to be added to trim pack 165 to match the density of vehicle 105 to that of the water. Depending on how the lookup table is implemented, the result of step 510 may also include a spatial distribution by which ballast components 420 should be installed in trim pack 165. The distribution of ballast components 420 may depend on the length and type of tether 115, the sensors in sensor package 120, as well as other factors that affect the distribution of mass within vehicle 105.

At step 520, ballast components 420 are selected that will provide the weight called for in step 515.

At step 525, the ballast components 420 selected in step 520 are installed in trim pack 165. This may vary, depending on the configuration of trim pack 165. One exemplary installation procedure may involve removing cover plate 410, placing the ballast components 420 at the respective aperture 415, and replacing cover plate 410. Alternatively, cover plate 410 and base plate 405 may be a single unit, and ballast components 420 may be directly inserted into apertures 415. One skilled in the art will readily recognize that many such variations to installing ballast components 420 in step 525 are possible and within the scope of the invention.

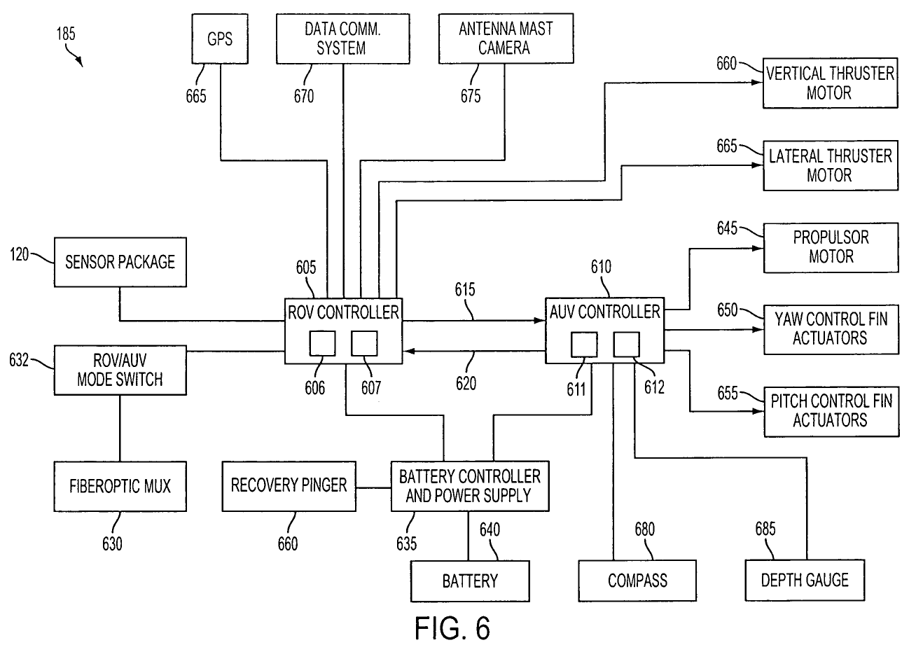

FIG. 6 illustrates an exemplary electronics system 185 according to the present invention. Electronics system 185 may include an ROV controller 605 and an AUV controller 610. ROV controller 605 may include an ROV processor 606 and an ROV memory device 607. ROV controller 605 may serve as a master controller for electronics system 185. ROV controller 605 provides control signals 615 to AUV controller 610, and AUV controller 610 provides telemetry signals 620 to ROV controller 605. ROV controller 605 accepts signal inputs from sensor package 120.

ROV controller 605 receives input signals from, and provides telemetry data to fiberoptic Multiplexer (MUX) 630. Fiberoptic MUX 630 transmits and receives signals to/from control console 110 over tether 115. ROV controller 605 also provides control signals to the vertical thruster motor 660 in the vertical thrusters 130 and to the lateral thruster motor 665 in the lateral thrusters 125.

Fiberoptic MUX 630 may be connected to an ROV/AUV mode switch 632, which switches vehicle 105 between ROV-mode and AUV-mode based on a signal received from the operator via fiberoptic MUX 630. Further, ROV/AUV mode switch 632 may switch vehicle 105 into fail-safe mode in response to either a command received by fiberoptic MUX 630, or in response to fiberoptic MUX 630 losing communications with control console 110. In the latter case, ROV/AUV mode switch 632 may switch vehicle 105 into fail-safe mode in response to the severing of tether 115. ROV-mode, AUV-mode, and fail-safe mode are described further below.

ROV-AUV mode switch 632 may be a standalone electronic component, such as a microcontroller, and the like. Alternatively, ROV/AUV mode switch 632 may be implemented in software and may include a series of instructions that are stored in ROV memory 607 and executed on ROV processor 606. Or, ROV/AUV mode switch 632 may be implemented in software and may include a series of instructions that are stored in AUV memory 612 and executed on AUV processor 611.

ROV controller 605 may communicate with GPS receiver 665, data communication system 670, and the (optional) camera mounted on antenna mast 150.

ROV controller 605 is connected to battery controller and power supply 635. Because ROV controller 605 may serve as a master controller for electronics system 185, ROV controller 605 may provide overall control of the power system for vehicle 105. Battery controller and power supply 635 is connected to a battery 640, which may include one or more power cells. The type of battery technology used in battery 640, and its power capacity, may be determined by one skilled in the art. Considerations in selecting the type of battery technology and power capacity include the power consumption of all the components within vehicle 105, the duration of the mission, size and mass constraints for vehicle 105, and the like.

Also connected to battery controller and power supply 635 is recovery pinger 660. Recovery pinger 660 may be a water-activated pinger, like those that are commercially available. Recovery pinger 660 may be integrated within the hull of vehicle 105. Recovery pinger 660 may operate the entire time that vehicle 105 is in the water. Alternatively, recovery pinger 660 may be switched on once vehicle 105 goes into fail-safe mode, which is described further below.

AUV controller 610 provides control signals to a propulsor motor 645 in propulsor 180, yaw control fin actuators 650 coupled to yaw control fins 170, and pitch control fin actuators 655 coupled to pitch control fins 175. AUV controller may include an AUV processor 611 and an AUV memory device 612. AUV controller 610 may communicate with a compass 680 and a depth gauge 685.

ROV memory 607 may be encoded with computer instructions and data, which ROV processor 606 executes to operate vehicle 105. These computer instructions and data (hereinafter the “ROV software”) perform processes to operate vehicle 105. Further, AUV memory 612 may be encoded with computer instructions and data (hereinafter the “AUV software”), which AUV processor 611 executes to operate propulsor motor 645, yaw control fin actuators 650, and pitch control fin actuators 655.

Vehicle 105 may operate in several modes, such as ROV-mode, AUV-mode, and fail-safe mode.

In ROV-mode, ROV controller 605 receives commands from and operator via control console 110 and tether 115. The commands provided by the operator include commands to go forward or reverse, translate vertically or laterally, yaw left or right, and pitch up or down. In accordance with the ROV software, ROV controller 605 executes the commands provided by the operator and provides telemetry data to the operator via fiberoptic MUX 630, tether 115, and control console 110. Telemetry data may include images acquired by camera 220 or sonar 205, antenna mast camera 675, position acquired by GPS receiver 665, housekeeping data related to battery 640, motors, actuators, compass 680, depth gauge 685, and the like.

When vehicle is in ROV-mode, the operator may have control of lateral thrusters 125, vertical thrusters 130, propulsor 180, yaw control fins 170, and pitch control fins 175. AUV controller 610 may have control over propulsor 180, yaw control fins 170, and pitch control fins 175. The operator controls propulsor 180, yaw control fins 170, and pitch control fins 175 components through AUV controller 610, whereby the operator may issue commands to ROV controller 605, which passes the commands to AUV controller 610. In accordance with the AUV software, AUV controller 610 provides appropriate control signals to propulsor motor 645, yaw control fin actuators 650, and pitch control fin actuators 655, to implement the commands provided by the operator. Alternatively, ROV controller 605 may take direct control of propulsor 180, pitch control fins 175, and yaw control fins 170 from AUV controller 610. In this case, ROV controller 605 may control propulsor 180, pitch control fins 175, and yaw control fins 170, without communicating through the AUV controller 610.

When in ROV-mode, vehicle 105 may hover, or operate at very slow speeds, as well as operate at high speeds. Generally, when in AUV-mode, vehicle 105 operates at higher speeds. At higher speeds, lateral thrusters 125 and vertical thrusters 130 may be ineffective, and vehicle may be driven primarily by propulsor 180, yaw control fins 170, and pitch control fins 175, using AUV controller 610. In the ROV-mode, the operator may operate the yaw control fins 170 and pitch control fins 175 via a closed loop control system, allowing operation at high speeds. The closed loop control system may be implemented by the AUV software.

In AUV-mode, AUV controller 610 generally has control of vehicle 105. In this case, the operator may provide directional commands to AUV controller 610, or commands to navigate to a particular location. In doing so, in accordance with the AUV software, AUV controller may use information from compass 680, depth gauge 685, and GPS receiver 665 (or some combination thereof) to implement a control algorithm that generates control signals to propulsor motor 645, yaw control fin actuators 650, and pitch control fin actuators 655.

Vehicle 105 may operate in AUV-mode until either the operator switches vehicle into ROV-mode, or vehicle 105 goes into fail-safe mode. In switching between ROV-mode and AUV-mode, the operator may issue a mode switch command from control console 110, which is received by fiberoptic MUX 630. Fiberoptic MUX 630 then relays the mode switch command to ROV/AUV mode switch 632. In an exemplary embodiment, ROV/AUV mode switch 632 is implemented in software, which is stored as a series of instructions in ROV memory 612 and executed by ROV processor 611. As discussed above, variations to this embodiment are possible and within the scope of the invention.

In fail-safe mode, vehicle 105 operates in a form of AUV-mode to navigate to a pre-planned location. This may happen under various conditions in which communication is lost with control console 105. For example, if tether 115 is severed by an obstacle, such as a submerged piece of jagged metal, ROV/AUV mode switch 632 may detect that communication between fiberoptic MUX 630 and control console 110 is lost. In this case, ROV controller 605 may provide a sequence of commands to AUV controller to navigate vehicle 105 according to a pre-loaded mission plan according to fail-safe mode. The commands and data corresponding to fail-safe mode may be stored in ROV memory 607, AUV memory 612, or distributed between both. The pre-loaded mission plan may include instructions for vehicle 105 to navigate to a particular location, and then either to surface, or descend to the bottom. In either case, recovery of vehicle 105 may be facilitated by recovery pinger 660.

Another event in which vehicle 105 may go into fail-safe mode includes tether 115 being fully extended, and sufficient tension is exerted to cause full extension cable cutter 325 to sever tether 115. In this case, communication with control console 105 is lost, and ROV controller 605 engages fail-safe mode in the same or similar manner as that described above.

When in either ROV-mode, AUV-mode, or fail-safe mode, vehicle may surface to use the components within antenna package 155 mounted on antenna mast 150. Once surfaced, vehicle 105 may acquire its present position using GPS receiver 665, communicate with host vessel via data communications system 670, and/or acquire imagery using the antenna mast camera 675 in antenna package 155.

Vehicle 105 may surface to use antenna package 155 under a variety of scenarios. First, vehicle 105 may surface to assist in navigation. This may be particularly important in long duration deployments of vehicle 105, or deployments in which vehicle 105 is expected to travel considerable distance from the host vessel. In this case, vehicle 105 may be operating in either ROV-mode or AUV-mode. In this scenario, vehicle 105 may surface periodically to determine its position.

Second, vehicle 105 may surface to obtain its position prior to diving. In either the first or second scenario, either ROV controller 605 or AUV controller 610 may obtain position data from GPS receiver 665, depending on the mode in which vehicle 105 is operating. Once the position is obtained, ROV controller 605 or AUV controller 610 may transmit its position to the host vessel via data communication system 670. Additionally, ROV controller 605 or AUV controller 610 may acquire one or more images using antenna mast camera 675 mounted in antenna package 155. The image data may be transmitted to the host vessel via data communication system 670.

Third, vehicle 105 may surface as a final stage of fail-safe mode. In this case, if vehicle 105 enters fail-safe mode as described above, AUV controller 610 may execute instructions stored in ROV memory 607 and/or AUV memory 612, corresponding to a pre-loaded mission plan. The pre-loaded mission plan may include navigating to a predetermined location and surfacing. Once surfaced, ROV controller 605 or AUV controller 610 may execute instructions to transmit predetermined signals and telemetry data via data communication system 670.

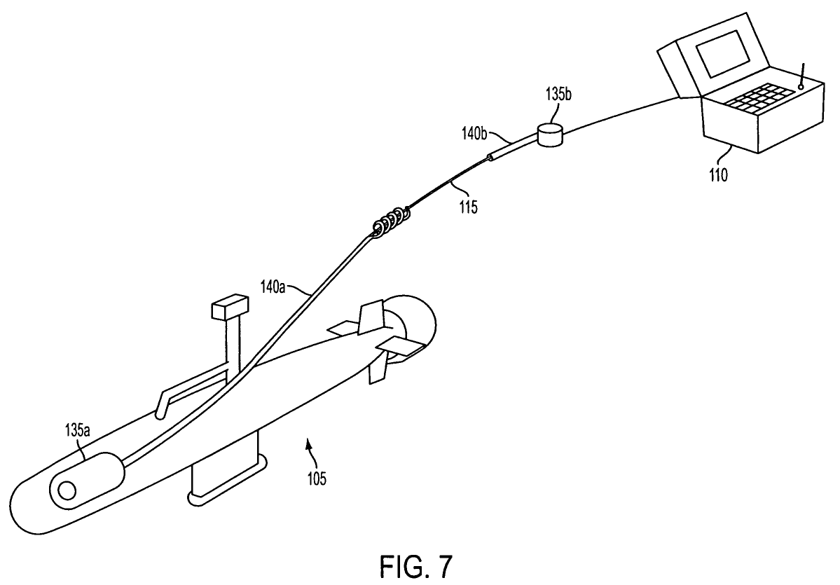

FIG. 7 illustrates an exemplary deployment of vehicle 105 and control console 110, wherein control console 110 may be operated from the deck of a ship, a dock, and the like. In this exemplary deployment, a second tether pack 135b is used in addition to tether pack 135a within vehicle 110. A second stinger guide 104b (or some modification thereof) may also be used in conjunction with second tether pack 135b.

By using two tether packs 135a and 135b, it may be possible to extend the distance to which vehicle 105 may be deployed. Further, tether pack 135b may be designed to feed out tether 115 either before, or simultaneously with, tether pack 135a. By simultaneously feeding out tether 115 from tether packs 135a and 135b, it may be possible to reduce the stress imparted on tether 115 by distributing the tension between the two tether packs 135a and 135b. Alternatively, if the control console located on the ship drifts from the initial launch position, tether 115 may feed out from second tether pack 135b, thereby reducing the amount to which tether 115 is fed out of tether pack 135a in vehicle 105.

Alternatives to vehicle 105 are possible and within the scope of the invention. For example, ROV controller 605 and AUV controller 610 may exist in a single on-board computer or controller having one or more memory devices. In this case, the terms ROV controller 605 and AUV controller 610 may refer to software entities that are executed in one or more processors using an operating system that allows multitasking. Further, ROV memory 607 and AUV memory 612 may refer to different memory spaces within a single memory device. Also, ROV processor 606 and AUV processor 611 may refer to distinct tasks or multitasking threads that are separately executed on a single processor device. One skilled in the art will readily appreciate that such variations are possible and within the scope of the invention.

Further, fiberoptic MUX 630 is an exemplary embodiment of a communications device that is coupled to tether 115. One skilled in the art will readily appreciate that the communications device may be a data communications device, acoustic underwater communications device, coax cable transceiver, and the like. As stated above, although the above description pertains to fiberoptic communications, one skilled in the art will readily recognize that other communication media may be used and are within the scope of the invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An underwater vehicle, comprising:
a tether;
a communications device coupled to the tether;
an ROV controller that controls the underwater vehicle according to an ROV-mode;
an AUV controller that controls the underwater vehicle according to an AUV-mode; and
an ROV/AUV mode switch that switches the underwater vehicle between the ROV-mode and the AUV-mode.

2. The underwater vehicle of claim 1, wherein the ROV controller comprises:
a processor; and
a computer readable medium encoded with instructions for operating the underwater vehicle in the ROV-mode;

3. The underwater vehicle of claim 2, wherein the ROV/AUV mode switch comprises a plurality of instructions that are encoded in the computer readable medium.

4. The underwater vehicle of claim 1, wherein the ROV/AUV mode switch switches the underwater vehicle into a fail-safe mode in response to a signal from the communications device.

5. An underwater vehicle, comprising:
a lateral thruster;
a vertical thruster;
a pitch control fin;
a yaw control fin;
a propulsor;
an ROV controller coupled to the lateral thruster and the vertical thruster; and
an AUV controller coupled to the pitch control fin, the yaw control fin, and the propulsor,
wherein the ROV controller is configured to communicate with the AUV controller.

6. The underwater vehicle of claim 5, wherein the ROV controller is configured to take direct control of the pitch control fin, the yaw control fin, and the propulsor from the AUV controller.

7. The underwater vehicle of claim 5, further comprising:
a communication device coupled to the ROV controller; and
a tether coupled to the communication device.

8. The underwater vehicle of claim 7, wherein the communication device includes a fiberoptic multiplexer, and wherein the tether includes a fiberoptic cable.

9. The underwater vehicle of claim 7, further comprising an ROV/AUV mode switch coupled between the communication device and the ROV controller.

10. The underwater vehicle of claim 5, wherein the vertical thruster comprises a thruster cover having a plurality of apertures, wherein a dimension of each of the plurality of apertures corresponds to a maximum thrust of the propulsor and a rigidity of the tether.

11. A vehicle, comprising:
a hull;
a tether pack disposed within the hull, wherein the tether pack has a length of tether; and
a stinger guide coupled to an aperture in the hull,
wherein the tether passes through the aperture and the stinger guide.

12. The vehicle of claim 11, wherein the tether pack comprises:
a case;
a full-extension cable cutter; and
at least one binder-stripping wheel.

13. The vehicle of claim 11, wherein the tether comprises a fiber optic cable.

14. The vehicle of claim 11, wherein the stinger guide comprises polyethylene.

15. The vehicle of claim 11, wherein the stinger guide comprises:
a guide portion; and
a tail portion, wherein the tail portion is cut into a spiral shape.

16. An underwater vehicle, comprising:
a hull;
an antenna mast disposed on a topside of the hull; and
a keel disposed on an underside of the hull,
wherein the keel has a trim pack disposed at an end of the keel.

17. The underwater vehicle of claim 16, wherein the antenna mast comprises a handle.

18. The underwater vehicle of claim 16, wherein the trim pack comprises:
a base plate;
a cover plate having a plurality of apertures; and
a plurality of ballast components disposed between the cover plate and the base plate,
wherein the plurality of ballast components has a combined weight corresponding to the density of the underwater vehicle and the density of the water in which the underwater vehicle is to be deployed.

19. The underwater vehicle of claim 16, further comprising a computer having a computer readable medium encoded with instructions and data corresponding to a lookup table, the lookup table having an input value corresponding to a water specific density and an output value corresponding to the combined weight of the ballast components.

20. The underwater vehicle of claim 16, wherein the trim pack is configured so that the underwater vehicle can rest on the trim pack when the underwater vehicle is placed on a flat surface.

21. The underwater vehicle of claim 16, wherein the trim pack is configured so that the plurality of ballast components can be distributed along a length of the keel.
